(19) United States
(12) Patent Application Publication
(10) Pub. No.: US 2003/0151925 A1
(43) Pub. Date: Aug. 14, 2003

(54) Lamp alignment-locking assembly

(76) Inventor: Paul D. Crunk, Woodcrest, MI (US)

Correspondence Address: Paul Crunk, 12220 Wooderest Street Box 725, Taylor, MI, 48180-0725, US

(21) Appl. No.: 10/076,259

(22) Filed: Feb. 12, 2002

(51) Int. Cl. F21V 21/00; F21V 15/04

(52) U.S. Cl. 362/545; 362/369; 362/390

(57) ABSTRACT

The present invention provides a solution to where many types of vehicle lamps used on and off roads is subject to considerable vibration and impact, which the lamps shifts, rotates, come loose or pop out of the mounting fixture, flange or application where they are secured to. With the use of the Lamp Alignment-Locking Assembly features will secure the lamps to the fixture or direct to the application and can also secure to the fixture to the application if a fixture is used, which will solve the many problems when vehicle lamps are subject to vibration or impact in vehicle or non-vehicle applications used on and off the roadways.

### FIELD OF THE INVENTION

The lamp alignment-locking assembly is to stop the lamp rotation and shifting or popping out of the mounting fixtures or precut holes.

### BACKGROUND OF INVENTION

The present invention relates to vehicle lighting used in many trucks and trailers, and many commercial applications used on an off the roadways worldwide that are very acceptable to vibration, in which the lamps rotate, shifts or pop out of the mounting fixtures or holes they are placed in.

Many Bulb and LED lamps particularly in large trucks and tractor-trailers and heavy construction equipment and small utility trailers sustain considerable vibration during their normal use on or off the roadways. Most all vehicle lamps and non-vehicle lamps being made today have a top and bottom area of the lamp.

This means the lamp has a vertical and horizontal light output and placement is critical when the lamp has been tested for it's vertical and horizontal light illumination. The problem is if the lamp due to vibration rotates out of its correct position the horizontal and vertical access of the light output becomes noncompliant to US federal laws and becomes non visible to other motorist when visibility is important for public safety during normal usage and in severe weather conditions when the lamp needs to be viewed by motorists in all types of weather conditions.

Most all vehicle lighting is mounted in a rubber grommet or uses a mounting flange. The problems with both of these mounting fixtures are there is no way to prevent them from rotating in these fixtures. This is a on going problem for vehicle lighting used on and off the highways on trucks, trailers, commercial equipment and small utility trailers etc, which sustains excess vibration due to the application or terrain being used on. Both the rubber grommet and flange fixtures mentioned above do hold the light at times very securely, but due to rain, ice, snow, dirt and oils getting in between the lamp and the fixture will allows the lamp to shift and rotate causing a visual problem to other motorist following behind that vehicle or is unsightly in appearance to the other lamps mounted in the correct mounting position.

### BRIEF DESCRIPTION OF THE DRAWING

The present invention will become more fully understood from a detailed description and the accompany drawings wherein.

FIG. 1 is a perspective view of the lamp case that has one tab 1 on the exterior of the case to fit into the mounting fixture, Flange 24, rubber grommet etc that has grooves for proper alignment and to hold it in place from shifting, which includes any other manufacture that offers standard rubber grommets without grooves or tabs and lamp can fit in alignment in any precut holes in an OEM or aftermarket installation application with grove or tabs.

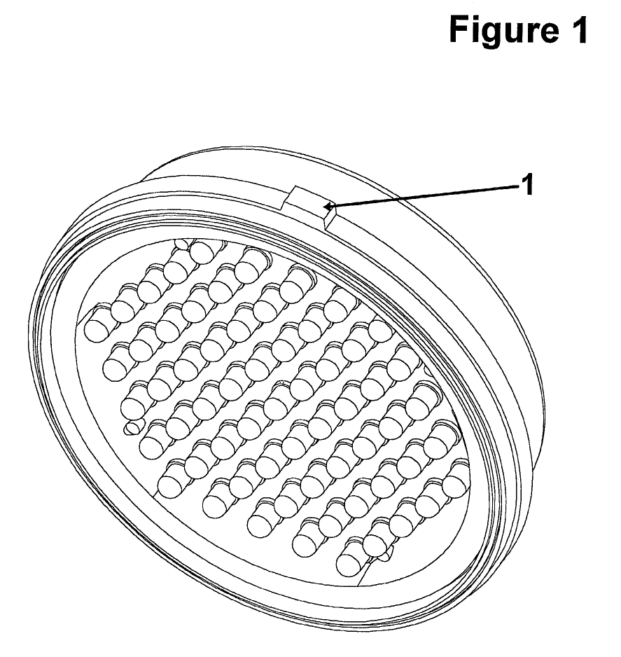

FIG. 2 is a perspective view of a lens 2 showing only two of the three grooves 3 that fits into a mounting fixture having one or more tabs (not shown) fits into the grooves 3 on the lens for proper alignment

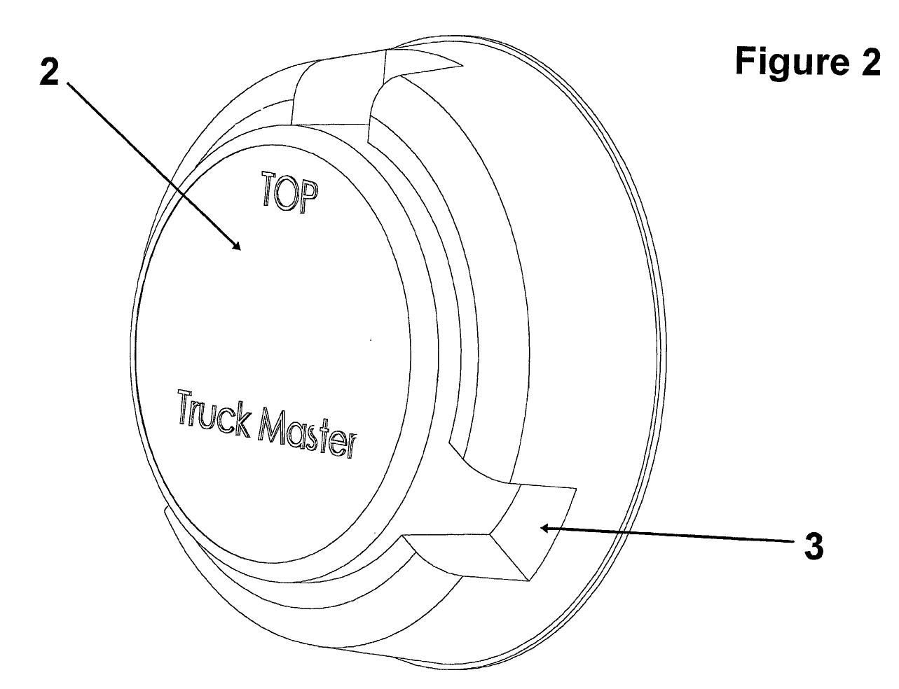

FIG. 3 is a perspective view of a four-inch lamp but can be any size showing the tab 4, reflector led PCB retainer ring 6 ultrasonic welded onto the case 5 with other components 6 already assembled in the lamp.

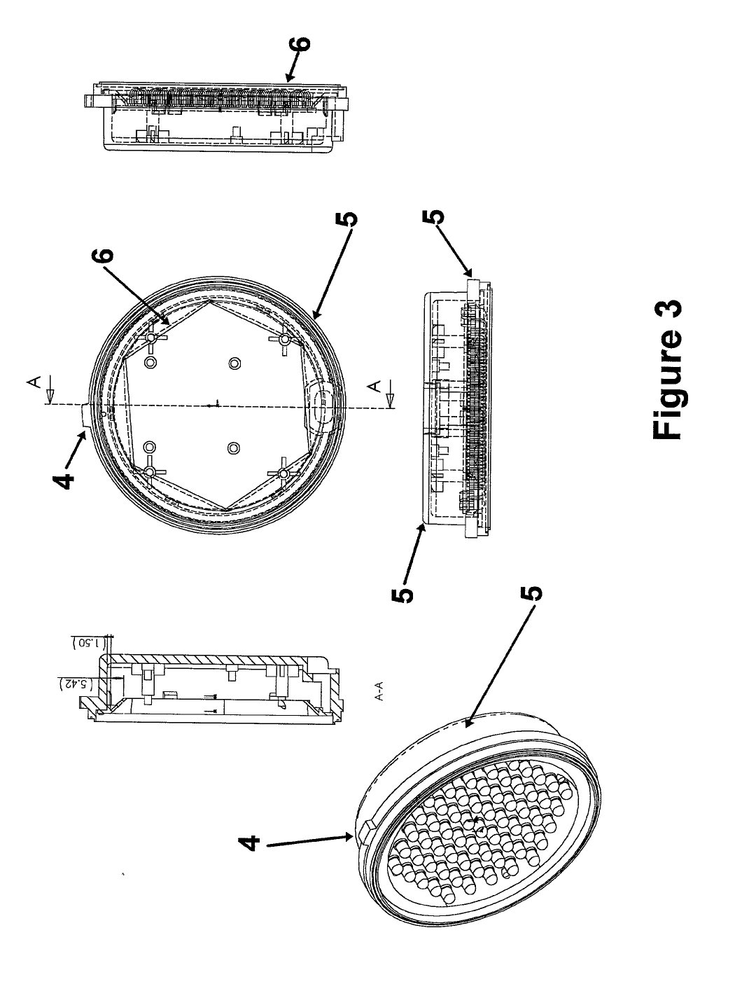

FIG. 4 is a perspective view a 2.5 inch marker lamp assembly showing the flange 7 the lens 8, the LED PCB board 9, the controller PCB board 10, the case back 11, and wire bushing socket 12, the lens 8 using alignment tabs 13 fit into notches/slots 14 in flange 7 and which three or more barbs 15 snaps lamp into place to hold the lamp securely in place in a flange 7 or lamp can be installed into a rubber grommet or any other type of fixture. Lamp case 11 or lens 8 can have one or more alignment tabs 13 on the exterior of the lens 8 that matches up with a mounting fixture flange 7 or rubber grommet having one or more slots/grooves 16 or uneven areas 17 to hold the lamp. Also one or more tabs 4 or 13 or grooves/slots 16 on the interior of the lens to align the PCBs and match up with the lamp back case 11 for proper alignment.

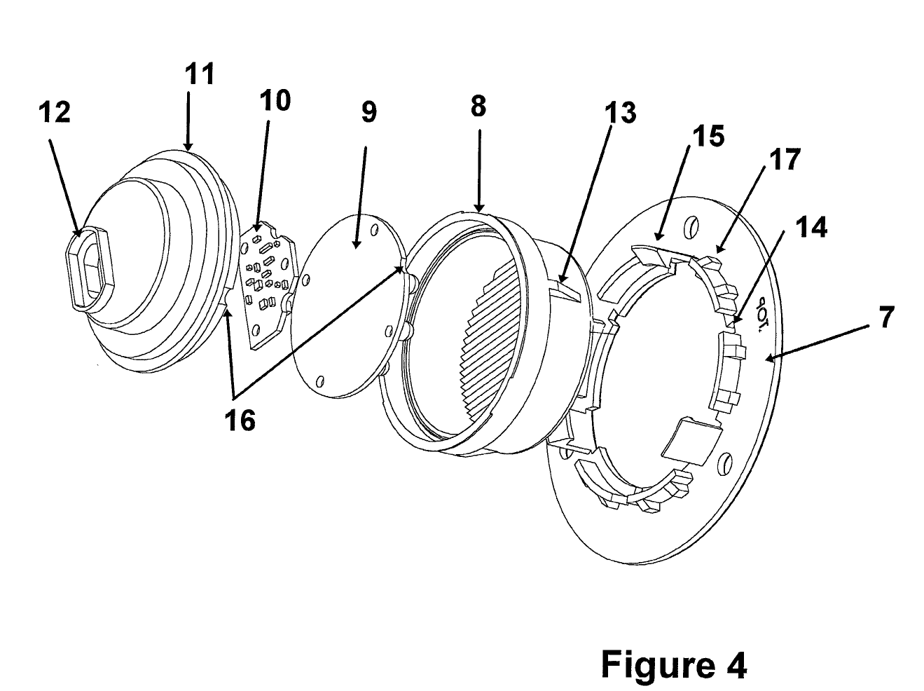

FIG. 5 is a perspective view of the 2.5 inch marker lamp 18 fully assembled in a plastic flange 7 showing the tabs 13 and notches 14 interlocking for proper alignment in the flange 7 which the flange clearly notes the top area 19 so the lamp top 20 is correctly positioned at the top area of the flange 7 for proper alignment before assembly with flange 7 having three or more holes 21 to mount the flange.

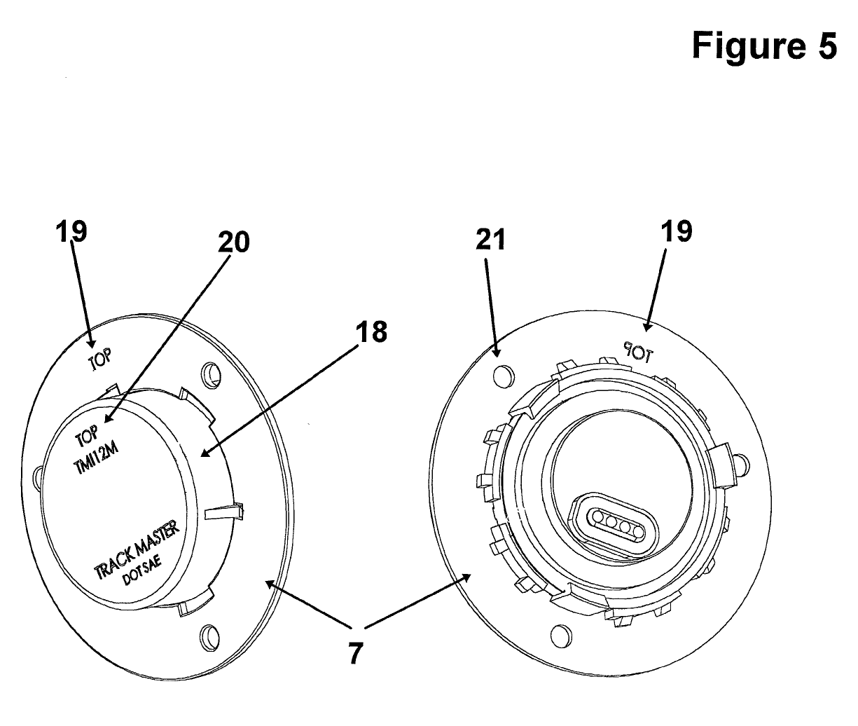

FIG. 6 is a perspective view of the four-inch tail turns stop lamp case 22 showing more than one tab 1 on the exterior of the case allowing a more secure fit into a flange or standard rubber grommet not shown.

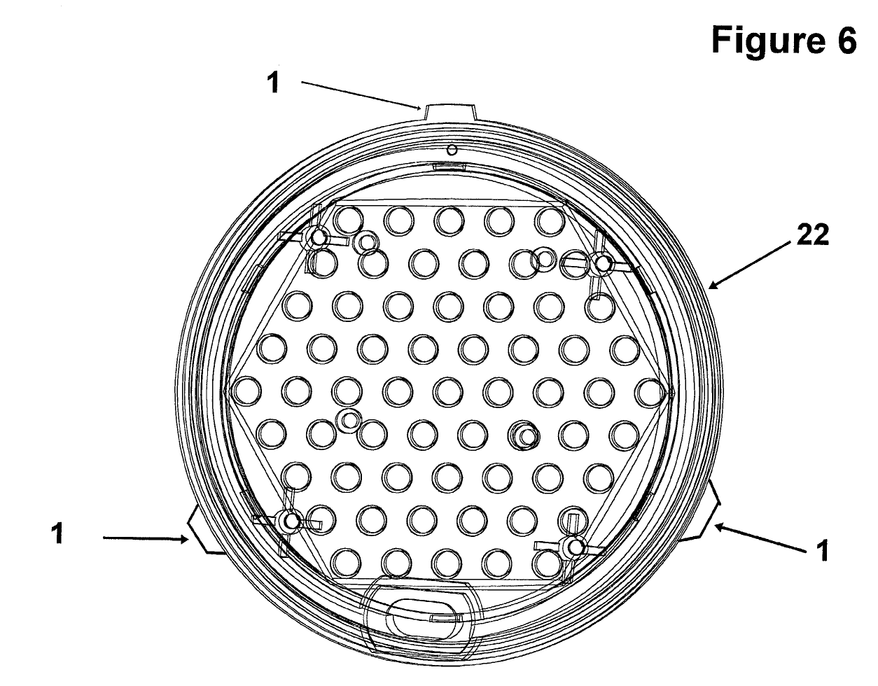

FIG. 7 is a perspective view of the plastic flange 7 showing notches 14 top 19 and many alignment tabs 17 including barbs 15 that slide over the lamp back 11 in FIG. 304 and snaps in tight with barbs 15, so the two fit together in the proper alignment and tight fit.

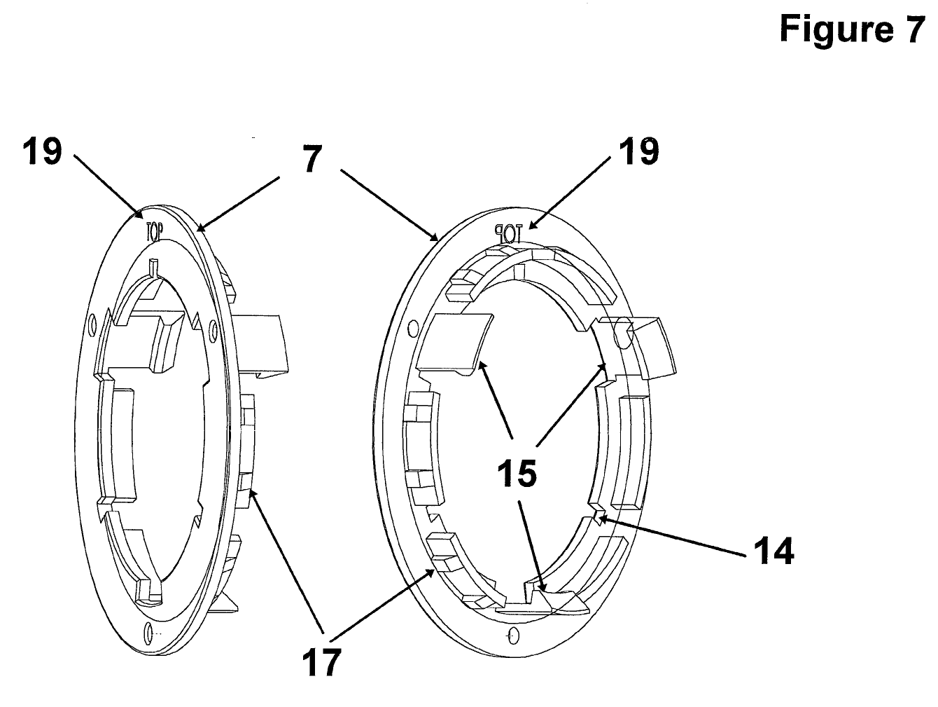

FIG. 8 is a perspective view of a 2.5 inch marker lamp clearly showing the notch 16 on the case back 11 that lines up with the tab 23 on the inside of the lens so the case and the lens property matches up in proper alignment for assembly for the top 19 on the lens.

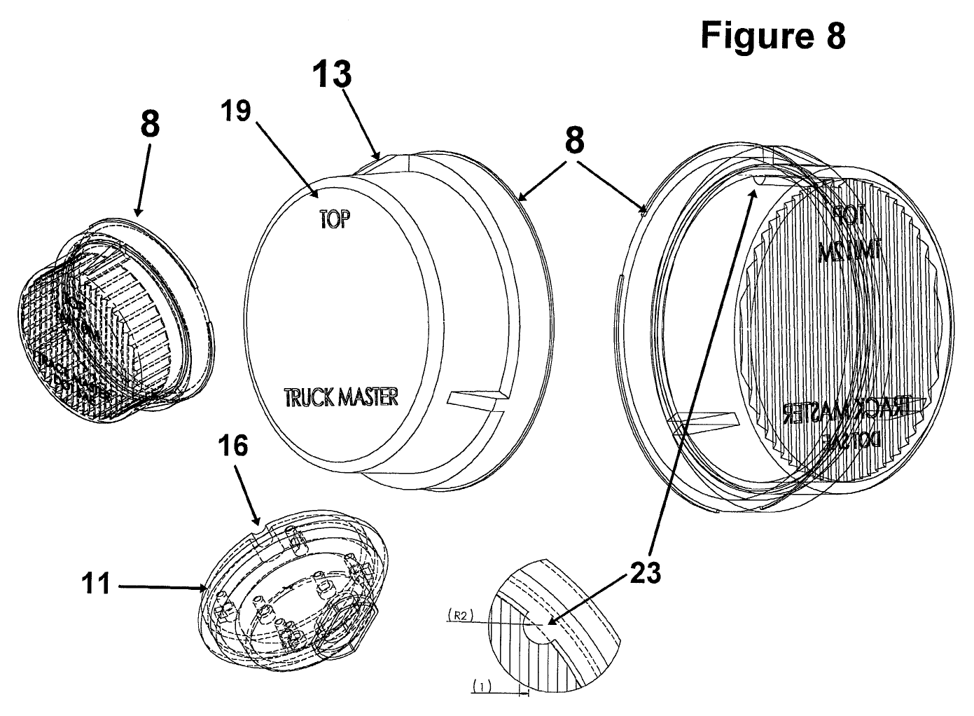

### SUMMARY OF THE INVENTION

The present invention provides the art of having an alignment tab/s on the outside of the case or lens or it a groove/s in the lamp itself that matches up with a case back. The flange or rubber grommet is what the lamp is usually place in when mounted to a vehicle like a truck or trailer of any size, which prevents the lamp from rotating in the fixture and also makes sure all things all line up. The lamp can have tab/s, barbs or a irregular areas sticking out from the lamp lens or case/housing which also helps secure the lamp from rotating in a rubber grommets because the tab, barbs or irregular area grabs into a standard rubber grommet to create a resistance factor, preventing the lamp from rotating in the fixture and keeping it from popping out of the rubber grommet when under vibration. At this present time all lighting manufacturers including led lighting manufacturers have problems of all type of lamps rotating in the many mounting fixtures including rubber grommets because of the vibration. With the help of this new invention by adding tabs, grooves or both, barbs or irregular areas on the case or lens will keep it from rotating or popping out from there mounting fixtures like a flange or rubber grommets and help to keep the lamp in alignment The flange can be made of plastic or metal or any other source adequate to mount a bulb or LED lamp in.

The present invention solves the problem of vehicle lamps rotating, shifting or falling out of most mounting fixtures or from precut holes cut or punched in vehicles or light and heavy equipment for use on and off the roadways worldwide.

This invention will help the lamp lock into place into precut hole or a mounting fixture like a flange or rubber grommet like a puzzle using alignment grooves and or tabs that match up with each other or create resistance in lock together to prevent the rotation or falling out of the lamp.

The flange can have either the grooves or tabs or irregular areas.

The lamp case or lens can have the grove or tab or areas that are irregular. It is like a puzzle, when the pieces fit together the grove/s and tab/s, which interlock will prevent shifting horizontal or vertical or forward or backward in a flange, rubber grommet or in a precut hole for any type of lamp.

When one or more tabs or irregular areas are placed on the lamp case or lens and it's then placed in a mounting fixture like a rubber grommet it will solve the problem of a lamp shifting or rotating or popping out do to many conditions.

The purpose of a flange is to allow the customer to choose between using a flange or rubber grommet. If the customer chooses to use the flange it then can be mounted to vehicle or trailer etc and allows the user the choice of using an optional lock ring over top of the flange and small portion of the lamp to prevent the lamp from be stolen out of the mounting fixture from the front viewing area.

The flange is an optional item. If the customer does not wish to use the metal or plastic flange they can place the lamp in an existing rubber grommet. The consumer can just purchase the lamp and place it in any brand of rubber grommet from any truck stop or dealer and put this lamp in it and it will stay in place because lamp alignment, locking assembly of the uneven surface of the case/housing or lens.

The flange can be made in any size and design, which in the exterior surface of the lamp case/housing or lens can be concaved or protruding making the lamp not shift in the mounting fixtures or rubber grommets by locking lamp in place.

What is claimed is:

1 A lamp having a notch, grooves, irregular areas or tab/s or unlimited number of notches, grooves irregular areas or tab/s on the case/housing or lens, which prevents the lamp from rotating, shifting backwards and forwards when mounted in a precut hole, fixture, flange or rubber grommet.

2 A mounting fixture having a notch, grooves, irregular areas or tab/s or barbs or unlimited number of notches, grooves irregular areas or tab/s, which prevents the lamp from rotating, shifting backwards and forwards when lamps is mounted in a precut hole, fixture, flange or rubber grommet.

3 A flange having a spring-loaded arm or arms of any shape or design which fits into a notch, grooves irregular areas or tab/s or unlimited number of notches, grooves irregular areas or tab/s on the case or lens, which prevents the lamp from rotating, shifting backwards and forwards when mounted

4 A lamp having a spring-loaded arm or arms of any shape or design with small or large hooks, barbs, which fits into a notch, grooves, irregular areas or tab/s or unlimited number of notches, grooves irregular areas or tab/s, which prevents the lamp from rotating, shifting backwards and forwards when mounted in a fixture, flange or rubber grommet.

5 A mounting fixture/flange having an unlimited number of locking barbs, grooves, tabs or irregular areas on the inside and or outside of the mounting fixture/flange that secures the lamp, which the barbs on a flange keep the lamp locked into place in the flange preventing any movement and also the locking barbs on the flange exterior will allow for quick mounting when inserted in a hole or application and will keep the fixture/flange secures in place when mounted.
